(19) United States
(12) Patent Application Publication
(10) Pub. No.: US 2018/0294686 A1
(43) Pub. Date: Oct. 11, 2018

(54) Stator for Rotating Electric Machine

(71) Applicant: Hitachi Automotive Systems, Ltd., Hitachinaka-shi, Ibaraki (JP)

(72) Inventors: Itsurou SAWADA, Tokyo (JP); Yutaka MATSUNOBU, Hitachinaka (JP); Akihito NAKAHARA, Tokyo (JP)

(21) Appl. No.: 15/573,878

(22) PCT Filed: Apr. 27, 2016
(86) PCT No.: PCT/JP2016/063124

§ 371 Date: Nov. 14, 2017

(30) Foreign Application Priority Data
May 22, 2015 (JP) 2015-104121

(51) Int. Cl. H02K 3/04; H02K 1/16; H02K 3/48; H02K 9/19

(52) U.S. Cl. CPC H02K 3/04; H02K 9/19; H02K 3/48; H02K 1/16

(57) ABSTRACT

The present invention provides a stator for a rotating electric machine that has a high efficiency and an excellent cooling performance. The stator of the present invention, includes: a stator iron core having a plurality of slots; and coil windings made by connecting segment conductors and disposed in the slots, in which each slot contains two or more of the coil windings electrically connected in parallel and at least one of the coil windings electrically connected in series with the coil windings connected in parallel.

### TECHNICAL FIELD

The present invention relates to a rotating electric machine, and more particularly, to a structure of a stator for a rotating electric machine.

### BACKGROUND ART

A rotating electric machine generates heat due to eddy current loss or joule loss when converting electrical input into mechanical output as a motor or converting mechanical input into electrical output as a generator.

Individual materials for a rotating electric machine have their own upper temperature limits. A motor or a generator should be cooled not to exceed the individual upper temperature limits of the parts made of the materials.

A rotating electric machine with a large loss requires a large input to achieve a certain output. The losses in a rotating electric machine are required to be reduced also in view of efficiency.

One known method for reducing the losses in a rotating electric machine is to improve a space factor by placing a plurality of generally U-shaped segment conductors in slots in a stator iron core, which is disclosed in PTL 1 and PTL 2, for example. The losses in a coil winding of a stator are categorized into two types: joule loss, which is caused when electric current flows through the coil winding; and eddy current loss, which is caused by the rotating magnetic field formed by the rotation of a rotor.

Joule loss is proportional to the product of the square of the electric current through a coil winding and the electric resistance in the coil winding. Eddy current loss is proportional to the square of the electric current through a coil winding and the square of the radial height of the coil winding.

### CITATION LIST

### Patent Literatures

PTL 1: JP 2014-100037 A
PTL 2: JP 2013-143786 A

### SUMMARY OF INVENTION

### Technical Problem

An object of the present invention is to provide a stator for a rotating electric machine that has a high efficiency and an excellent cooling performance, and a rotating electric machine including the stator.

### Solution to Problem

To solve the above problems, an embodiment of the present invention adopts the structures described in the claims of the present invention, for example. The present application includes a plurality of means for solving the above problems. For example, there is provided a stator, including: a stator iron core having a plurality of slots; and coil windings made by connecting segment conductors and disposed in the slots, in which each slot contains two or more of the coil windings electrically connected in parallel and at least one of the coil windings electrically connected in series with the coil windings connected in parallel.

### Advantageous Effects of Invention

The present invention provides a stator for a rotating electric machine that has a high efficiency and an excellent cooling performance, and a rotating electric machine.

### BRIEF DESCRIPTION OF DRAWINGS

FIG. 1 is a cross-sectional view of a stator according to a first embodiment of the present invention.

FIG. 2 is a cross-sectional view of a rotating electric machine according to the first embodiment of the present invention.

FIG. 3 shows temperature reduction effects according to the first embodiment of the present invention.

FIG. 4 is a cross-sectional view of a stator according to a second embodiment of the present invention.

FIG. 5 shows an electric vehicle including the rotating electric machine of the present invention.

FIG. 6 shows an electric vehicle including the rotating electric machine of the present invention for driving a rear wheel.

### DESCRIPTION OF EMBODIMENTS

Embodiments of the present invention will now be described with reference to the accompanying drawings.

In the following description, a motor for driving an electric vehicle will be described as an example for a rotating electric machine.

### Embodiment 1

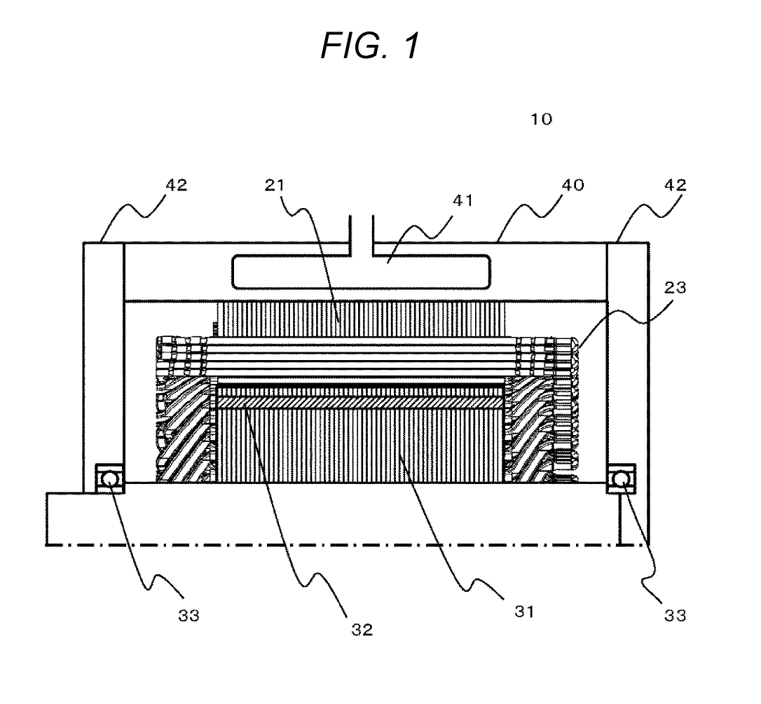

FIG. 1 is a cross-sectional view of a rotating electric machine including a stator of the present invention, taken along the plane parallel to the rotation axis.

A rotating electric machine 10 includes a stator 20 having a stator iron core 21 and a stator winding coil 23 wound in a stator slot 22 formed in the axial direction of the stator iron core, a rotor 30 having a rotor iron core 31 and a permanent magnet 32 disposed in the rotor iron core, a bearing 33 rotatably supporting the rotor 30, a bracket 42 holding the bearing, and a housing 40 holding the stator.

FIG. 1 shows a liquid-cooled jacket 41 for cooling the stator 20 in the housing 40; however, the liquid-cooled jacket may be omitted.

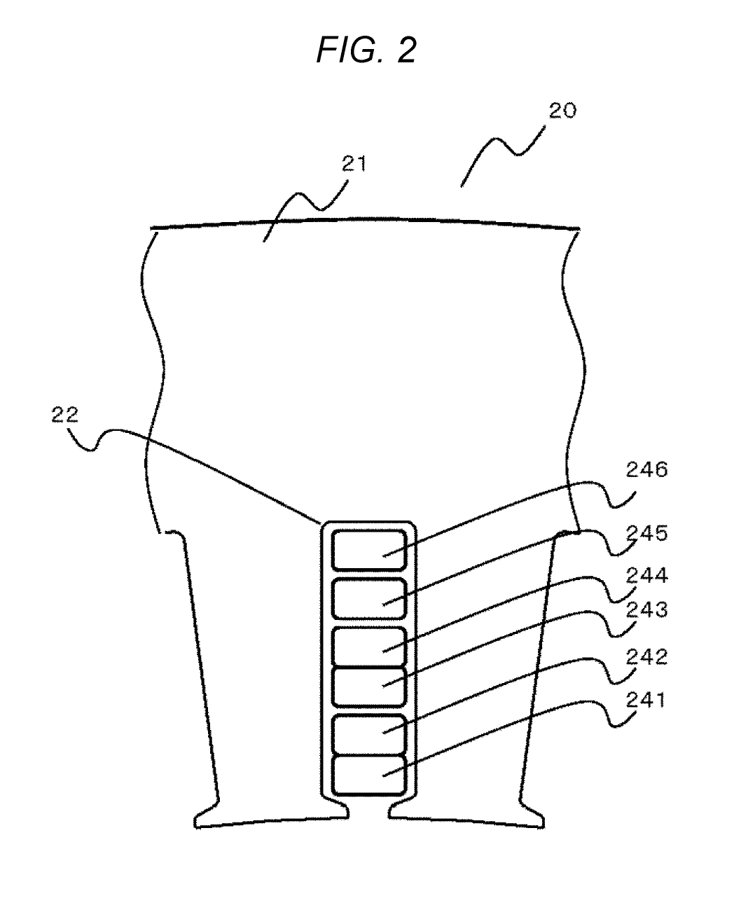

FIG. 2 is a cross-sectional view of the stator 20 of the present invention, taken along the plane orthogonal to the rotation axis.

A stator slot 22 in the stator 20 contains a plurality of stator winding coils 23. In FIG. 2, a coil 241 and a coil 242 are connected with each other at the ends in the direction of the rotation axis, and a coil 243 and a coil 244 are connected with each other at the ends in the direction of the rotation axis. The coils 241 and 242 are disposed near the inner side of the stator slot 22.

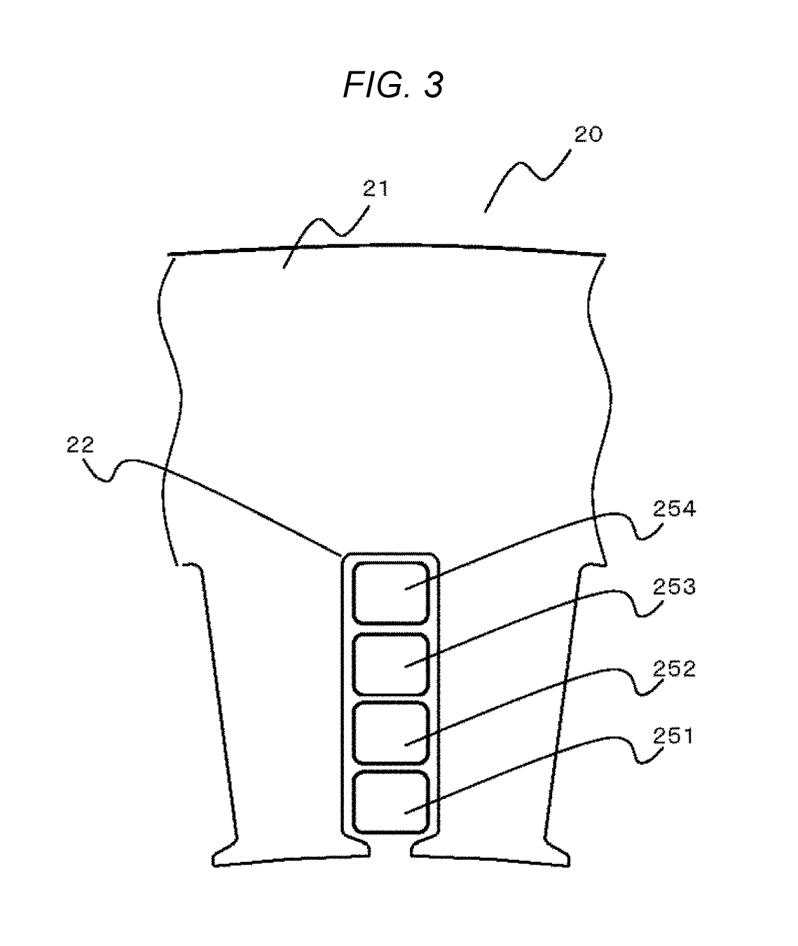

The six stator winding coils (241 to 246) in the stator slot 22 are electrically equivalent to four stator winding coils (251 to 254) in a stator shown in FIG. 3.

The following conditions are met to simplify the description give later.

(1) The stator slot 22 in FIG. 2 has the same dimensions as the stator slot 22 in FIG. 3.

(2) The occupation rate of the stator windings in the stator slot 22 (the space factor) in FIG. 2 is the same as the occupation rate of the stator windings in the stator slot 22 (the space factor) in FIG. 3.

(3) The six stator winding coils (241 to 246) in FIG. 2 have the same cross-sectional dimensions. (4) The four stator winding coils (251 to 254) in FIG. 3 have the same cross-sectional dimensions. (5) Eddy current loss caused in a stator winding coil is proportional to the product of the square of the electric current through the stator winding coil and the square of the radial thickness. The eddy current loss is caused only in the innermost coil in the stator slot.

Under the above conditions, the radial thickness of one stator winding coil in FIG. 2 is expressed by h×4÷6, where h represents the radial thickness of one stator winding coil in FIG. 3.

Since the stator winding coils in FIG. 2 have the same width as the stator winding coils in FIG. 3, the ratio between the radial thicknesses is equal to the ratio between the cross-sectional areas of one stator winding coil.

Since the electric resistance in one stator winding coil is proportional to the cross-sectional area of the stator winding coil, the ratio between the radial thicknesses of the stator winding coils is equal to the ratio between the electric resistances in the stator winding coils.

Joule loss Pa caused in the stator winding coils in FIG. 3 is expressed by

Pa=4×Î2×R,

where I represents the electric current equally flowing through the four stator winding coils (251 to 254) and R represents the electric resistance in one of the stator winding coils.

As for the six stator winding coils (241 to 246) in FIG. 2, the electric resistance in one of the stator winding coils, which is inversely proportional to the cross-sectional area, is expressed by R×6÷4.

The electric current through each of the stator winding coils connected in parallel (241 to 244) is expressed by I÷2, and the electric current through each of the stator winding coils connected in series (245 and 245) is expressed by I.

Accordingly, joule loss Pb caused in the stator winding coils in FIG. 2 is expressed by

$$\begin{matrix}Pb = 4 \times {( I \div 2 )}^{⋀} 2 \times ( R \times 6 \div 4 ) + 2 \times {I}^{⋀} 2 \times ( R \times 6 \div 4 ) \\ = 4.5 \times {I}^{⋀} 2 \times R .\end{matrix}$$

In addition, when Qa represents eddy current loss caused in the innermost stator winding coil 251 in the stator slot 22 in FIG. 3, eddy current loss Qb caused in the innermost stator winding coil 241 in the stator slot 22 in FIG. 2 is expressed by

$$\begin{matrix}Qb = Qa \times {( 1 \div 2 )}^{⋀} 2 \times {( 4 \div 6 )}^{⋀} 2 \\ = Qa \div 9.\end{matrix}$$

The sum total Wb of the joule loss and the eddy current loss caused in the stator winding coils in FIG. 2 and the sum total Wa of the joule loss and the eddy current loss caused in the stator winding coils in FIG. 3 are respectively expressed by

$$\begin{matrix}W b = Pb + Qb \\ = 4.5 \times {I}^{⋀} 2 \times R + Qa \div 9\end{matrix}$$

$$\begin{matrix}Wa = P a + Qa \\ = 4 \times {I}^{⋀} 2 \times R + Qa .\end{matrix}$$

When Wb is smaller than Wa, that is, when Wb−Wa=0.5×Î2×R−Qa×8÷9<0 holds, the total loss in this embodiment shown in FIG. 2 is smaller than the total loss in the case shown in FIG. 3.

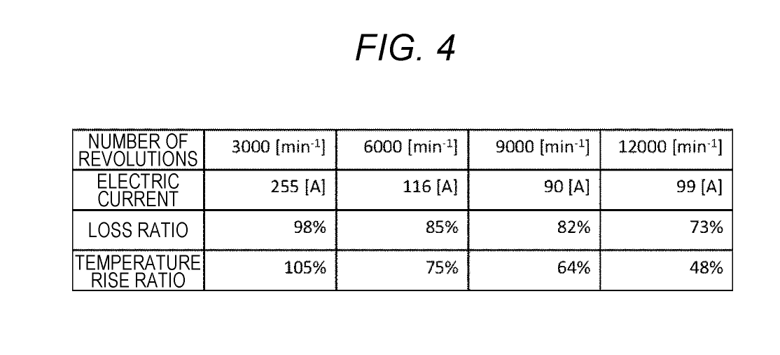

FIG. 4 shows the losses determined by electromagnetic analysis and the temperature rises caused by the losses. In FIG. 4, “loss ratios” are the ratios of the losses in this embodiment shown in FIG. 2 to the losses in the structure shown in FIG. 3, and “temperature rise ratios” are the ratios of the maximum temperature rises in this embodiment shown in FIG. 2 to the maximum temperature rises in the structure shown in FIG. 3. The loss ratios and the temperature rise ratios smaller than 100% show that the respective values in this embodiment shown in FIG. 2 are small.

As shown in FIG. 4, the loss ratios are smaller than 100% under all the conditions, which means that the losses in this embodiment are small and the efficiency is improved.

In addition, the temperature rise ratios are also smaller than 100% under the three conditions except for the condition that the number of revolutions is 3000[min̂(−1)], which means that the temperature rises in this embodiment are reduced.

As described above, according to this embodiment, a stator for a rotating electric machine that has a high efficiency and a small temperature rise can be provided.

As a secondary effect, the present invention enables manufacture of stators with six-turn stator windings and stators with four-turn stator windings (six winding coils including two pairs of winding coils connected in parallel, which are electrically equal to four-turn winding coils) shown in this embodiment in the same production facilities.

In this embodiment, six winding coils includes two pairs of winding coils connected in parallel as shown in FIG. 2; however, the number of winding coils connected in parallel is not limited in the present invention.

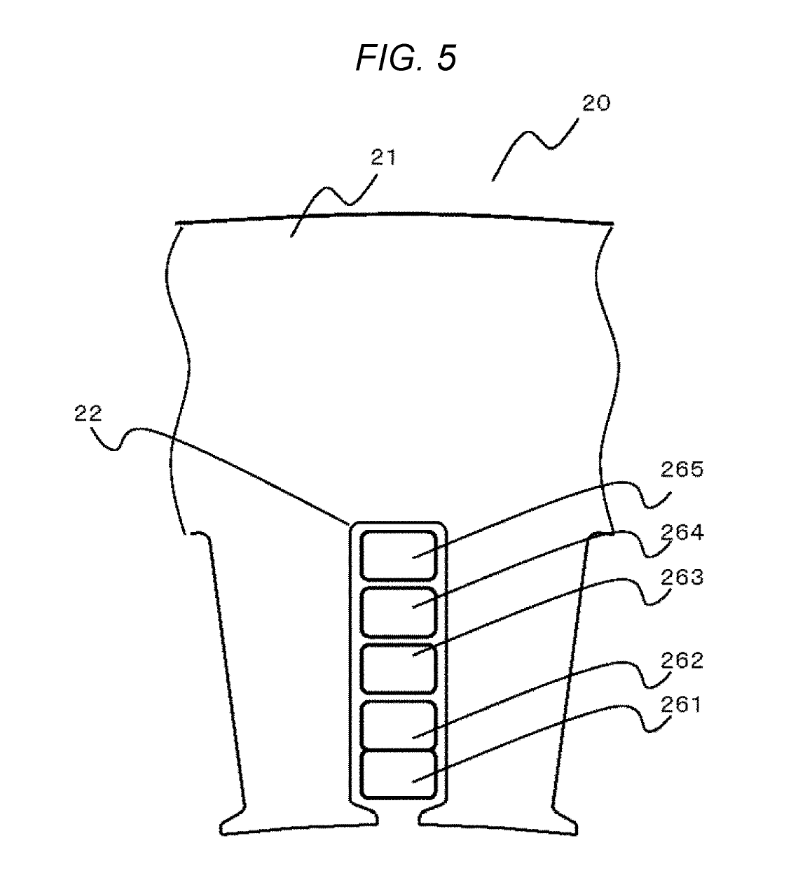

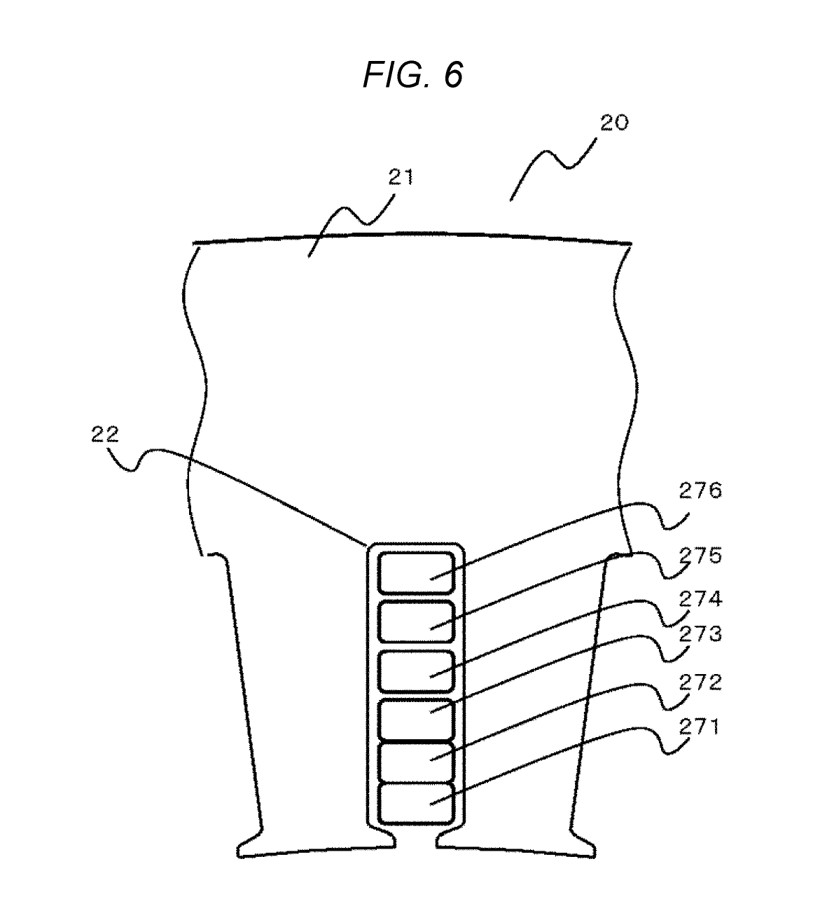

For example, as shown in FIG. 5, five winding coils (261 to 265) may include a pair of winding coils connected in parallel (261 and 262), or as shown in FIG. 6, six winding coils (271 to 276) may include a group of three winding coils connected in parallel (271 to 273).

In any case of FIG. 2, FIG. 5, and FIG. 6, the coils disposed near the inner side of the stator slot 22 are connected in parallel; however, coils in other areas may be connected in parallel.

It is known, however, that most eddy current loss is caused near the inner side of the stator slot 22. Under these circumstances, connecting the winding coils near the inner side of the stator slot 22 in parallel has a greater effect on efficiency improvement.

As shown in FIG. 1, when the liquid-cooled jacket 41 is disposed near the outer circumference of the stator 20 for cooling purposes, reducing the losses in the winding coils far from the liquid-cooled jacket has a greater effect on reduction in the maximum temperature rises. Accordingly, it is preferable to connect the winding coils near the inner side of the stator slot 22 in parallel as shown in FIG. 2 also in view of the temperature rise reduction.

### REFERENCE SIGNS LIST

10 rotating electric machine
20 stator
21 stator iron core
22 stator slot
23 stator winding coil
241 winding coil connected in parallel
242 winding coil connected in parallel
243 winding coil connected in parallel
244 winding coil connected in parallel
251 winding coil connected in series
252 winding coil connected in series
253 winding coil connected in series
30 rotor
31 rotor iron core
32 permanent magnet
33 bearing
40 housing
41 liquid-cooled jacket
42 bracket
50 electric vehicle
51 engine
52 gearbox
53 wheel
54 power converter
55 controller
56 condenser
57 axle
60 control signal line
61 direct current line
62 alternating current line

1. A stator, comprising:
a stator iron core having a plurality of slots; and
coil windings made by connecting segment conductors and disposed in the slots,
wherein each slot contains two or more of the coil windings electrically connected in parallel and at least one of the coil windings electrically connected in series with the coil windings connected in parallel.

2. The stator according to claim 1, wherein the coil windings in the slots have generally the same cross-sectional shape.

3. The stator according to claim 1, wherein the coil windings connected in parallel are disposed nearer to the inner circumference of the stator than the other coil windings in each slot.

4. The stator according to claim 1, wherein the coil windings are wound in a wave winding manner.

5. A rotating electric machine, comprising:
the stator according to claim 1; and
a rotor rotatably held with a predetermined gap from the stator.

6. The rotating electric machine according to claim 5, wherein the rotating electric machine is for driving an electric vehicle.

7. The rotating electric machine according to claim 5, wherein the stator is cooled by a liquid-cooled jacket disposed near the outer circumference of the stator.

8. An electric vehicle, comprising:
the rotating electric machine according to claim 5,
wherein the rotating electric machine is for driving a rear wheel of the electric vehicle.
